(19) United States
(12) Patent Application Publication
(10) Pub. No.: US 2008/0232219 A1
(43) Pub. Date: Sep. 25, 2008

(54) High throughput system for legacy media conversion

(76) Inventors: Yugal K. Sharma, Washington, DC (US); Tad Richman, Washington, DC (US); Kurt Beyer, Mill Valley, CA (US); Rajan Arora, Washington, DC (US)

Correspondence Address: Nields & Lemack, 176 E. Main Street, Suite #5, Westboro, MA, 01581, US

(21) Appl. No.: 12/075,982

(22) Filed: Mar. 14, 2008

Related U.S. Application Data
(60) Provisional application No. 60/918,548, filed on Mar. 16, 2007.

(51) Int. Cl. G11B 7/28

(52) U.S. Cl. 369/85

(57) ABSTRACT

A system and method for creating digital content from a plurality of legacy media formats, such as paper, CD, VHS, DVD, etc. A coordination node is utilized to balance the computation load between the various processing units, particularly those involved in the second stage of operation. Extraction units are used to input various types of information into the system as digital media. Once the information has been extracted, the coordination node and its associated software determine the load on each processing unit in the second stage and based on this and other factors, determine which processing unit will perform the conversion. The output is then stored in storage devices. This approach maximizes system utilization, while being more cost efficient than traditional extraction systems.

This application claims priority of U.S. Provisional application Ser. No. 60/918,548 filed Mar. 16, 2007, the disclosure of which is incorporated herein by reference.

### BACKGROUND OF THE INVENTION

As technology moves forward, it leaves behind a wake of information in a variety of formats that may not be desired for future applications. For example, consider the history of written materials. For centuries, written material was painstakingly copied by hand. Later, with the advent of the printing press, printed materials, such as books and manuscripts, began to replace hand-written material. Presently, with the advent of electronic media and communication, another information format, electronic digital media, such as electronic books, is poised to replace or at least co-exist with printed material. Several entities have announced ambitious plans to electronically publish the world's literary collection.

A similar migration is apparent with entertainment media. For audio material, there has been a plethora of formats, such as vinyl recordings, which existed at 33, 45 and 78 RPM, cassette recordings, and 8-Track recordings. All of these formats are nearly extinct today, replaced by digital media, such as compact disks (CDs). To date, there are almost 16 billion CDs in circulation in the United States, with over 600,000,000 new CDs added to this number each year. CDs represented 97% of all music sales in 2005, and the vast majority of music will probably remain on physical CDs for many years to come. DVDs has also reached its zenith as the preferred distribution vehicle for commercial movies. In 2006 the sale of rental market for DVDs in the US reached $25 billion, while ticket sales grossed $10 billion. At the same time, portable digital players, digital media centers, and digital music servers continue to proliferate at an exponential rate, while radio stations, online music stores, and internet-based music require this growing archive of music CDs to be digitized to a variety of CODECs and formats. Thus, while technology continues to move forward, it is also diverging. Previously, the single standard used by CDs served the needs of nearly every user. Today, users demand digital media in a variety in different, and often incompatible formats, for use with MP3 players, iPODs®, personal computers, DVD players, etc.

As daunting as the conversion of entertainment media appears, the entirety of the world's written and printed document library is orders of magnitude larger. The personal computer revolution, combined with advances in office print, copy, and Ethernet technology, has resulted in the current paper document crisis. The crisis, however, has also led to a recent boom in the document management industry. This boom is supported by a multitude of trends, some obvious, and others less so:
Information Overload: As paper documents proliferate so too does the cost of storage, indexing, and retrieval.
Sarbanes-Oxley and New Regulations: Enron and Anderson learned the hard way that proper records management and evidence discovery in the event of litigation are increasingly critical.
Document Security: Hurricane Katrina demonstrated that vital records preservation is a key element in developing a disaster recovery plan.
National Security: As evidenced by the war on terror, complex knowledge management systems are needed to compress security decision cycles from months to minutes.
   While the idea of digitalizing this information for safekeeping and disaster recovery is compelling, it is not without drawbacks. For instance, replacing paper medical records with a connected electronic network would take about 15 years and would cost hospitals about $98 billion and physicians about $17 billion according to a 2005 study published in the Journal of Health Affairs. Given the large amount of these legacy documents that exist today, a solution that emphasizes conversion speed while maintaining accuracy is sorely needed.

Presently, practitioners in the field use a multistage approach to converting legacy data:

Stage 1: Extraction
Extraction of raw data from original media into computable format

Stage 2: Conversion
Error correction/enhancement of raw data
Conversion of corrected raw data
Data categorization (metadata, keywords, etc)
Digital Rights Management

Stage 3: Storage of Final Product

The second stage is by far the most computationally intensive step, sometimes taking orders of magnitude more time than the initial stage, depending on the type of conversion. Special attention must be paid to this stage, and it is here where current solutions fall short.

Typically, current systems employ dedicated computers to handle each stage of this process. FIG. 1(a) depicts an example of a prior art system, which illustrates a serial configuration using four separate clones. A clone is defined a standalone configuration supports extraction, conversion and storage. Scalability is achieved by increasing the number of clones to accommodate the desired throughput. Note that, as shown in FIG. 1A, there is no communication or interdependency between the clones.

The major drawback with these prior art systems can be broken down into two different, but related problems:
scalability/cost-efficiency, and
resource management.

The cost effectiveness of scaling is the greatest drawback of most prior art systems. Though these systems can be scaled by replicating more clones, the costs associated with this scaling will also increase, but inefficiently. This is a direct result of the lack of concordance in processing efficiency between the initial stage and the second stage. Since the second stage is far more compute intensive than the initial stage, a clone's throughput is typically defined by the throughput of this stage. To increase the throughput of the system, additional clones must be added to relieve the bottleneck in the second stage. However, typically, the initial stage is lightly loaded and able to handle an increased load. Due to the tight linkage between stages, additional stage 1 equipment must be purchased due to bottlenecks caused by the second stage. The larger this discrepancy in throughput, the larger the cost-inefficiency associated with scaling up becomes. Prior art systems offer no options to bridge this discrepancy—it is an inherent part of the system.

The second drawback is the ineffective allocation of resources. Without intercommunication between all components in the initial stage and the second stage processing, resources cannot be dynamically adjusted as volume fluxes occur. Additionally, as each Stage 2 conversion node becomes filled with files to be converted, it is likely one clone will finish its processing before the others. If there is no more initial stage processing, this clone will sit idle while the others still content with a backlog of files to convert. Thus, there are two different types of inefficiency. The first is the inefficiency between the various stages of a single clone. As stated above, in most prior art systems, each processing unit within the clone has a specific function. For example, the processing units in the first stage are dedicated to extracting information into digital formats. When idle, these units cannot relieve the second stage processing units of some of the conversion work. Thus, these first stage units sit idle while the second stage units are overworked. This period of idle time will increase proportionally with the difference in processing times for Stage 1 versus Stage 2. The larger the discrepancy, the longer the potential idle time, leading to significant wasting of valuable resources.

To illustrate, the idle time, T_{idle}, depends on:

rate of extraction (Rₑ),

rate of conversion (R_{c}),

number of extraction nodes (n),

batch size (S), and

number of batches (m), according to equation (1):

$${T}_{idle} = {\sum }_{k = 1}^{n} m ( \frac{{S}_{k}}{{R}_{c}} - \frac{{S}_{k}}{{R}_{e}} ) \qquad ( 1 )$$

Typically R_{c} is much slower than Rₑ, sometimes orders of magnitudes slower. If R_{c} can be increased to match Rₑ, T_{idle} will approach zero.

The second form of inefficiency is due to the lack of communication between the various clones. For example, it is conceivable that the second stage processing units for a particular clone are idle, while those of another clone have multiple tasks queued. If intercommunication existed between all Stage 1 and Stage 2 components, the idle resources could be identified, and files in the backlog could be dynamically reallocated to the idle processors. Without this type of interaction in place, systems cannot reach 100% utilization.

Therefore, a system that addresses these shortcomings would be advantageous, especially since the conversion of information stored on physical media to a portable digital format is a valuable, necessary transition to keep pace with technology.

### SUMMARY OF THE INVENTION

The shortcomings of the prior art have been addressed by the present invention, which describes a system and method for creating digital content from a plurality of legacy media formats, such as paper, CD, VHS, DVD, etc. The invention utilizes a coordination node to balance the computation load between the various processing units, particularly those involved in the second stage of operation. Extraction units are used to input various types of information into the system as digital media. Once the information has been extracted, the coordination node and its associated software determine the load on each processing unit in the second stage and based on this and other factors, determine which processing unit will perform the conversion. The output is then stored in storage devices. This approach maximizes system utilization, while being more cost efficient than traditional extraction systems.

### BRIEF DESCRIPTION OF THE FIGURES

FIG. 1(a) illustrates a typical media extraction system of the prior art;

FIG. 1(b) illustrates the topology of the media extraction system of the present invention;

FIG. 2 illustrates one embodiment of the media extraction system of the present invention;

FIG. 3 is a pictorial representation of the coordination software workflow; and

FIG. 4 is a graph depicting the cost efficiencies made possible by the present invention.

### DETAILED DESCRIPTION OF THE INVENTION

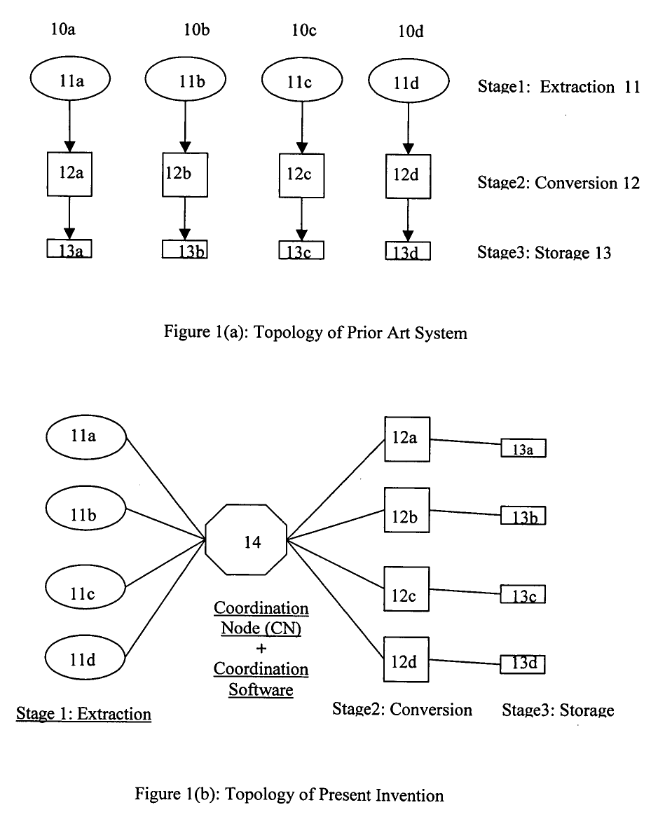

As stated above, FIG. 1(a) illustrates a typical media extraction system of the prior art. Note that the system topology exists of a number of clones 10a-10d. Each of these clones includes an extraction stage 11, a conversion stage 12 and a storage stage 13. There is no intercommunication between clone systems, therefore each is actually a system unto itself. As described above, because of this topology, system inefficiencies occur. For example, if unit 12a is idle, while unit 12b is busy, with multiple jobs queued for execution, it is not possible to offload the excess work from unit 12b to unit 12a. Additionally, these systems can only be scaled by purchasing additional clones that consist of all three stages. Therefore, even if the performance is limited only by stage 2 units 12a-12d, the user is forced to buy additional stage 1 units 11 and stage 3 units 13.

In contrast, a representative topology of the present invention is illustrated in FIG. 1(b). Note that in addition to the extraction units 11, the conversion units 12 and the storage units 13, there is a coordination node 14. Data which has been extracted by extraction units 11 is sent to the coordination node 14, preferably in the form of jobs. This node monitors the activity of all conversion units 12 and sends the new job to an idle conversion unit. If all conversion units are not idle, the job is held by the coordination node in a queue.

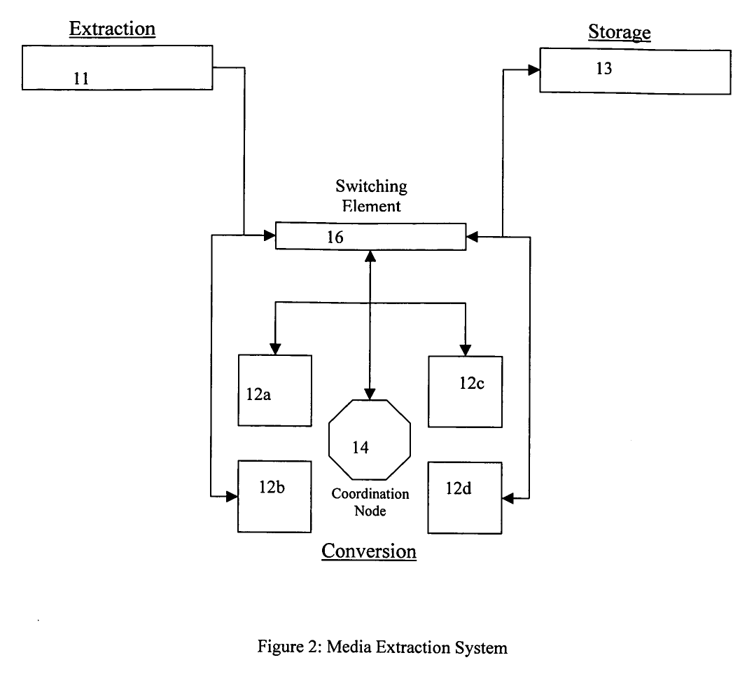

FIG. 2 illustrates one embodiment of the present invention. The extraction stage 11 and the storage stage 13 are in communication with a centralized switching element 16. In one embodiment, a gigabit Ethernet switch is used. However, other implementations, including fiber channel, token-ring, Firewire® or other communication formats can be utilized as well without departing from the invention. Also in communication with the centralized switching element are the extraction units 12, and the coordination node 14. Note that in the preferred embodiment, the coordination node is a separate component from any of the other stages. However, such a configuration is not required. For example, the coordination node and its associated software could be included within one of the conversion units 12 if desired. In that case, all jobs would be received by a single conversion unit, which would then distribute the jobs to the other conversions units as required. Similarly, the functionality might exist on an extraction unit 11. The only requirement is that there is a coordination point. It is an implementation decision as to whether it is a stand-alone device or integrated with another function.

In FIG. 2, all jobs that are completed by the extraction stage 11 are passed to the coordination node 14 for distribution among the various conversion units. The extraction units 11 are responsible for accepting legacy media formats and extracting them into a standard format that can be used by the conversion units 12. The media types that may serve as input to the extraction units include documents, audio and video.

More precisely, the documents may be in the form of paper documents, such as but not limited to loose-leaf pages, booklets, bound materials, and the like. These papers are input into the system by way of an image scanner, preferably one capable of automatically feeding multiple sheets. In one embodiment, the papers can be scanned and saved in graphical format until they reach the conversion stage. Alternatively, these documents may already be in electronic format and currently available on a form of digital media, such as a CD. In this case, the extraction unit is preferred equipped with a CD/DVD drive, capable of extracting the necessary files from the CD. Additionally, the extraction unit may also include a robotic arm. This arm is used to pick up discs from a first, unprocessed, receptacle, and insert them into the media reader. A detailed example of such an extraction system is described in co-pending applications, titled “Automated Audio Extraction” and “Image Analysis for Use with Automated Audio Extraction”, the disclosures of which are hereby incorporated by reference.

Audio input to the extraction units may be in the format of audio compact discs (CDs), or older analog audio sources, such as cassettes, 8-Track cassettes, or long-playing phonographs (LPs). Additionally, the LPs may be based on different rotational speeds, such as 33 RPM, 45 RPM or 78 RPM. Additionally, the audio input may be in the form of steaming audio data. Note that while the above formats are the most common, other audio input formats are possible and within the scope of the invention.

Video input can be in multiple formats as well. These include Video Home System (VHS) cassettes, DVDs, streaming video or projector reels. Note that while the above formats are the most common, other video input formats are possible and within the scope of the invention. In the case of CDs or DVDs, an extraction unit would be equipped with at least one CD/DVD drive. In the preferred embodiment, multiple CD/DVD drives are installed on each unit, where each can be extracting data simultaneously. The drive loading mechanism is implementation dependent, and may include manual or robotic loading.

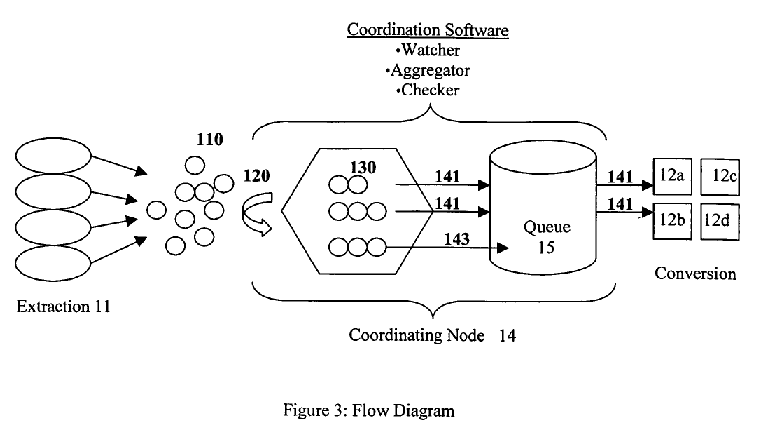

The coordination node 14 is responsible for centrally overseeing the distribution of jobs to the conversion units. FIG. 3 provides an overview of the functionality of the coordination node and specifically its associated software. The software preferably consists of 3 major components. For simplicity, these components are known as the Watcher, the Aggregator and the Checker functions. The functions performed by each will be described in more detail in conjunction with FIG. 3. While the preferred embodiment utilizes three major components, the software need not be divided in this manner. Other software implementations are within the scope of the invention.

Referring to FIG. 3, the coordination process begins as the extraction stage processes input data and presents job requests to the coordination node, shown in step 110. These job requests are submitted to the coordination node and received by the Watcher function, shown in step 120. The Watcher function serves to look for newly created job requests from the extraction node(s) and pass them to the Aggregator function.

The Aggregation function analyzes the various job requests and preferably collects them in batches, which are based on system resources, conversion type and job characteristics, as shown in step 130. For example, some conversion types are more compute intensive than others, and therefore fewer of these types will be aggregated into a single batch job. The coordination node preferably maintains a database, detailing the various conversion types, and their expected computation needs. As new types of conversions are added, these conversion types are benchmarked and folded into the database. The Aggregation function optimizes the number of conversions in a single batch job, using the data in the database concerning the computation needs of each conversion type. Having aggregated the various incoming job requests into batches, the coordination node then looks to distribute them to the various conversion units 12.

The Checker function is responsible for this distribution process. First, it determines whether any of the conversion units 12 are idle. If so, the next job batch is assigned to that unit and is subsequently executed until completion, as shown in step 141. The Checker continues by determining whether additional conversion units are idle and assigning job batches to them until either there are no more idle conversion units or there are no more job batches. If the Checker function determines that there are no idle conversion units, it will save the pending job batches in a queue 15, as shown in step 143. The Checker function continuously monitors the status of the various conversion units and as soon as one becomes idle, the next job batch in the queue is assigned to that unit. If, instead, there are idle jobs but a lack of job batches, the Watcher function will await the arrival of the next job batch is assign it immediately to an idle conversion unit.

The conversion stage is responsible for converting the incoming job batch from its current format to the desired final format. It is expected that all jobs within a batch will require the same final format. In one embodiment, all jobs within a batch also have the same original format. This enables the conversion unit to perform a single type of operation, using a single type of codec throughout the entire job batch.

As an example, audio processing involves the compression of the raw data to a new audio format. Some of these audio formats include, but are not limited to, MP3, WMA, AAC, and FLAC. Each of these formats requires a different codec, and preferable these codecs are accessible to all conversion units in the second stage. This allows any conversion unit to compress the raw data into the format specified by the job batch.

Video processing requires a similar array of codecs to encode the error-corrected raw data into a plurality of formats, including but not limited to WMV, AVI, MPG, and MOV.

Document processing of paper documents, scanned in by the extraction units, require the implementation of optical character recognition (OCR) software applied to the error-corrected document image. OCR is a very compute intensive algorithm and as such is particularly suited to the present invention. Prior to parsing by OCR, there are also a series of computational intensive steps. Automated document segmentation and layout analysis are dependent on a clear understanding and integration of language morphology and linguistic display principles. Statistical analysis and AI heuristics are used to collect data about page structure and style, automatically identifying and classifying titles, indexes, tables, pictures, columns, and rows. These master text zones must then be run through several statistical checks based on previous documents to flag pages that may contain discrepancies beyond a given threshold. Identified pages run through more aggressive algorithms, with the goal of the multi-step feedback system that becomes more accurate as the numbers of documents are ingested.

Following document parsing by OCR, the data is preferably saved in a flexible, extensible format, such as SGML, XML, or others. These formats can readily be converted to the desired final format. These possible final formats include but are not limited to Abode Acrobat PDF, MS Word 2003/XP/2000/97/95, MS Excel 2003/XP/2000/97/95, MS Powerpoint 2003/XP, Rich Text Format, Text, Unicode Text, HTML, Unicode HTML, DBF (Database file format), CSV (Comma Separated Value records) and Unicode CSV.

Although the stage is referred to as the “Conversion Stage”, it is not a requirement that the files actually be converted to a different format. For example, the conversion unit may simply do significant processing of a file, such as determining the metadata to associate with a text file, or encrypting the file without converting the file to a different format. Thus, the term “conversion” also includes processor intensive operations performed on the file.

Once the various input types have been successfully converted to the desired final format, an additional step of categorizing the data can be performed. This typically involves generating and using information about the data, or metadata. In the case of audio and video data, this metadata includes such items as artist, album, song title, year, etc. In the case of document processing, this involves parsing the file to create a searchable database of terms. This allows for efficient indexing and increases the value of the electronic conversion of documents. In both cases, this data can be manually entered or can be generated automatically. When attempting to develop a high-speed extraction system, it is preferable that as much of the metadata generation is automated as possible.

In the case of document classification, a software application can be used to prompt the user to enter information about the type of document that has been digitized. There are various types of documents, including but not limited to employee personnel records, patent filings, medical records, manuscripts, etc. Once the document class is identified, it can then be associated with a particular ontology. Each ontology would have a defined set of metadata used to tag the document. Alternatively, the classification can be done automatically by parsing the document text and identifying its type based on the data within the digitalized file. Based on this parsing, ontologies can be automatically created.

In the case of audio or video files, metadata can be attached by utilizing one of the many 3^{rd} party databases that currently exist. Most of these databases accept information about the particular album, such as number of tracks, the time for each track, and use that to determine the metadata (artist, album title, album artwork, year, etc.). This metadata can then be added to the audio or video files within the extraction system. Alternatively, a more comprehensive method of metadata creation, assembly and integration is described in a co-pending application, entitled “System and Method for Creating, Verifying and Integrating Metadata for Audio/Video Files.”

Once the job batch has been converted to its final format, it needs to be stored in the third stage of the system 13. In the preferred solution a series of RAID (Redundant array of Independent Disks) storage servers is used. Storage demands can be met simply by adding additional storage servers to the system. In one embodiment, the coordination software described above is also used to monitor the status of each storage server. As job batches are completed, the software assigns a destination based on the status of each storage unit. This status may be based on the amount of remaining storage on a particular unit, its current workload and other parameters. Alternatively, the final location may be based on the type of data that is to be saved. For example, it may be beneficial to save all documentation on a single storage unit. Conversely, it may be beneficial to spread the documentation files across multiple units. The actual allocation of output files is an implementation decision. Furthermore, the software may also monitor the duration that data has existed on the storage system, and can purge data that has been on the system more than a specified amount of time.

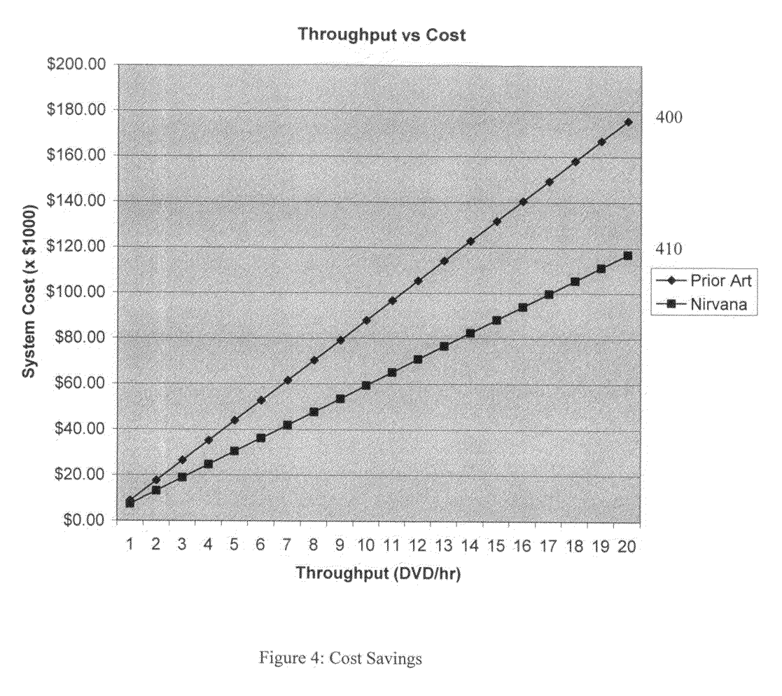

Not only does the present invention provide a high-speed legacy extraction system, but it does so in a cost-efficient manner. FIG. 4 shows a representative chart showing the relative costs for a prior art system as compared to the present invention in DVD processing at a variety of throughputs. To understand this chart, it is necessary to describe the various stages that DVD processing encounters. The first stage, extraction, is simply the copying of the data from the DVD into the computer system. On a typical personal computer with 4 GB of memory and a DVD drive, this extraction step consumes about 6 minutes. The second stage, or conversion stage, takes significantly longer. A rough estimation is that conversion to DivX format consumes approximately 3.5 hours. Since the second stage is much more compute intensive, it is typical that the computer used in this stage is more robust. For example, a dual processor system may be employed. In the chart of FIG. 4, it is assumed that stage one computing units cost approximately $1000; while second stage computing units cost roughly $1500. These costs are simply estimates and are used to illustrate the cost advantages associated with the present invention. Similar results are achieved when other costs are assumed. This chart also assumes that the same type of computers in used in both the prior art configuration, and the present invention. In other words, the computers for the initial stage of both configurations cost $1000, while the second stage computers cost $1500.

The X axis reflects the desired throughput, in DVD/hr. For the prior art system, as shown in FIG. 1(a), the number of stage 1 computers must equal the number of stage 2 computers. Thus, the system grows together, i.e. if there are ten stage 2 computers, there must be ten stage 1 computers. In the example given above, the throughput is severely constrained by the second stage. Thus, to achieve the desired system throughput, more stage 2 computers must be added. However, the addition of a stage 2 computer results in the unnecessary addition of another stage 1 computer. This phenomenon drives the cost curve for prior art systems, as shown in line 400 in FIG. 4. In general, the following equations provide a rough estimation of the system requirements of a prior art system:

1/System Throughput=(Tₑ+T_{c})/N,
where throughput is in DVD/hr;
N is the number of clones that are installed;
Tₑ is the time in hours required for extraction;
and T_{c} is the time in hours required for conversion.

System Cost=N*(Cₑ+C_{c}),
where system cost is in dollars,
N is the number of clones that are installed;
Cₑ is the cost of a single extraction system; and
C_{c} is the cost of a single conversion system.

In contrast, each stage of the present invention is scalable independent of other stages. Therefore, if the conversion stage is the major constraint on system throughput, additional stage 2 processing units may be added without adding additional stage 1 processing units. Consequently, the other equations are modified as shown below:

1/System Throughput=Tₑ/Nₑ+T_{c}/N_{c},
where throughput is in DVD/hr;
Nₑ is the number of extraction systems that are installed;
N_{c} is the number of conversion systems that are installed;
Tₑ is the time in hours required for extraction; and T_{c} is the time in hours required for conversion.

System Cost=Nₑ*Cₑ+N_{c}*C_{c}+C_{cn}
where system cost is in dollars,
Nₑ is the number of extraction systems that are installed;
N_{c} is the number of conversion systems that are installed;
Cₑ is the cost of a single extraction system;
C_{c} is the cost of a single conversion system; and
C_{cn} is the cost of a single coordination node.

Optimization of the above equations for system cost yields the results shown in line 410 of FIG. 4. This reduced cost curve is predominantly due to the fact that the coordination node is able to efficiently utilize the available resources, and the ability to scale each stage independently. This reduces idle time, which maximizes throughput and efficiency, thus reducing system cost.

What is claimed is:

1. A system for converting media to an electronic format, comprising:
a. an extraction unit for accepting an item in one format and transforming it to a first electronic format;
b. a coordination node for accepting said items from said extraction unit and distributing them to a plurality of conversion units; and
c. said plurality of conversion units for accepting said items in said first electronic format from said coordination node and converting said items into a second electronic format, selected from a plurality of possible electronic formats.

2. The system of claim 1, further comprising a storage unit to store said item after said item has been converted to said second electronic format.

3. The system of claim 1, wherein said coordination node further comprises software instructions to aggregate a plurality of said items into a batch job before distributing said plurality of items to one of said plurality of conversion units.

4. The system of claim 1, wherein said conversion units further comprise software instructions to add metadata to said item converted to said second electronic format.

5. The system of claim 1, wherein said extraction unit and said plurality of conversion units each comprise a discrete computing element.

6. The system of claim 1, wherein said coordination node is a discrete computing element.

7. The system of claim 5, wherein one of said conversion units comprises said coordination node.

8. The system of claim 5, wherein said extraction unit comprises said coordination node.

9. The system of claim 1, wherein said coordination node comprises a database, wherein said database comprises information related to the computation needs of each of said plurality of possible electronic formats.

10. The system of claim 1, wherein said item accepted by said extraction unit comprises paper documents.

11. The system of claim 1, wherein said item accepted by said extraction unit comprises compact disks.

12. The system of claim 1, wherein said item accepted by said extraction unit comprises digital video disks.

13. The system of claim 1, wherein said item accepted by said extraction unit comprises vinyl records.

14. The system of claim 1, wherein said item accepted by said extraction unit comprises video cassettes.

15. A method of converting items in one format to a desired electronic format, selected from a plurality of electronic formats, comprising:
a. Inputting said item into an extraction unit, where it is transformed into a first electronic format;
b. Distributing said item in said first electronic format to one of a plurality of conversion units; and
c. Using said one of a plurality of conversion units to convert said item from said first electronic format to said desired electronic format.

16. The method of claim 15, wherein a plurality of items is inputted to said extraction unit and after transformation into said first electronic format, said plurality of items are aggregated together prior to distribution to said one of said plurality of conversion units.

17. The method of claim 15, further comprising storing said item in said desired electronic format in a storage medium.

18. The method of claim 15, further comprising using said conversion unit to incorporate metadata into said item in said desired electronic format.

19. A system for converting media to an electronic format, comprising:
a. an extraction unit for accepting an item in one format and transforming it to a first electronic format;
b. a coordination node for accepting said items from said extraction unit and distributing them to a plurality of conversion units; and
c. said plurality of conversion units for accepting said items in said first electronic format from said coordination node and processing said items.

20. The system of claim 19, further comprising a storage unit to store said item after said item has been converted to said second electronic format.

21. The system of claim 19, wherein said coordination node further comprises software instructions to aggregate a plurality of said items into a batch job before distributing said plurality of items to one of said plurality of conversion units.

22. The system of claim 19, wherein said conversion units further comprise software instructions to add metadata to said item.

23. The system of claim 19, wherein said extraction unit and said plurality of conversion units each comprise a discrete computing element.

24. The system of claim 19, wherein said coordination node is a discrete computing element.

25. The system of claim 19, wherein one of said conversion units comprises said coordination node.

26. The system of claim 19, wherein said extraction unit comprises said coordination node.

27. The system of claim 19, wherein said item accepted by said extraction unit comprises paper documents.

28. The system of claim 19, wherein said item accepted by said extraction unit comprises compact disks.

29. The system of claim 19, wherein said item accepted by said extraction unit comprises digital video disks.

30. The system of claim 19, wherein said item accepted by said extraction unit comprises vinyl records.

31. The system of claim 19, wherein said item accepted by said extraction unit comprises video cassettes.

32. The system of claim 19, wherein said coordination node comprises a database, wherein said database comprises information related to each of said items.
